(19) United States
(12) Patent Application Publication
(10) Pub. No.: US 2019/0292427 A1
(43) Pub. Date: Sep. 26, 2019

(54) HOT MELT APPLICABLE STRUCTURAL ADHESIVES

(71) Applicant: Zephyros, Inc., Romeo, MI (US)

(72) Inventors: Laurent Meistermann, Molsheim Cedex (FR); Eric Elkaim, Molsheim Cedex (FR)

(21) Appl. No.: 16/302,898

(22) PCT Filed: May 16, 2017
(86) PCT No.: PCT/EP2017/061749

§ 371 Date: Nov. 19, 2018

(30) Foreign Application Priority Data
May 19, 2016 (EP) 16170340.0

(51) Int. Cl. C09J 163/00; C08J 9/10; C09J 11/06

(52) U.S. Cl. CPC C09J 163/00; C08J 9/102; C08J 9/107; C08J 9/106; C08J 2363/00; C08J 2201/026; C08J 2203/02; C08J 2203/04; C08J 2207/02; C09J 11/06

(57) ABSTRACT

The invention relates to a structural adhesive formulation, which is heat activatable at a heat activation temperature; meltable without heat activation at an application temperature above its melting point and below the heat activation temperature; and solid at ambient temperature; wherein upon heat activation the structural adhesive formulation is capable of expansion with a volumetric expansion of up to about 250 vol.-%; wherein the heat activatable structural adhesive formulation comprises (a) an epoxy resin component; (b) an adhesion promoter component; (c) a cross-linking component; (d) a blowing component; (e) optionally, an impact modifier component; (f) optionally, a thixotropic filler component; and (g) optionally, a non-thixotropic filler component. The structural adhesive formulation is particularly useful for application by means of a hot melt applicator, preferably a hand held hot melt gun.

The invention relates to a structural adhesive formulation, which is preferably particulate, which is heat activatable at a heat activation temperature; meltable without heat activation at an application temperature above its melting point and below the heat activation temperature; and solid at ambient temperature; wherein prior to heat activation the structural adhesive formulation preferably has a melt viscosity at 90° C. of about 600±595 Pa·s, preferably within the range of from 10 mPa·s to 1000 mPa·s; wherein upon heat activation the structural adhesive formulation is capable of expansion with a volumetric expansion of up to about 250 vol.-%; wherein after heat activation at the heat activation temperature and cooling down to ambient temperature the structural adhesive formulation preferably has a lap shear resistance of about 12±7 MPa, more preferably within the range of from 8 MPa to 15 MPa, and/or a glass transition temperature of at least about 70° C. a glass transition temperature of at least about 70° C., more preferably at least about 90° C.; wherein the heat activatable structural adhesive formulation comprises (a) an epoxy resin component; (b) an adhesion promoter component; (c) a cross-linking component; (d) a blowing component; (e) optionally, an impact modifier component; (f) optionally, a thixotropic filler component; and (g) optionally, a non-thixotropic filler component. The structural adhesive formulation is particularly useful for application by means of a hot melt applicator, preferably a hand held hot melt gun.

Longitudinal beads of heat activatable adhesive formulation are used in many industries to provide bond lines between substrates such as for example in the bonding together of substrates to form a component for an automobile. A bead of heat activatable adhesive formulation is deposited on and adhered to a substrate at a temperature below the activation temperature of the adhesive formulation and is subsequently activated at a higher temperature to bond two substrates together.

US 2004/0260012 A1 relates to a reactive hot melt composition which has adhesion and curing properties, and can be formulated into free-flowing pellets or beads, by using an ethylene-acrylic acid copolymer, and ethylene-methacrylic acid copolymer, and/or an ethylene-acrylic acid methacrylic acid terpolymer as a component of the composition along with free radical crosslinking initiators. The incorporation of a foaming agent enables the production of compositions which are useful in space-filling applications, (i.e., as so-called “anti-flutter” compositions). These adhesive formulations may be expandable with a volume expansion of up to 250%.

US 2006/127584 discloses methods and apparatuses for applying melt flowable materials to components of articles of manufacture. The methods and apparatuses are concerned with formation of appropriate flowable materials, control over the manner in which the flowable materials are applied, treatment of the components prior to application of the flowable materials and the like. Moreover, the apparatuses and methods may be particularly suited for applying flowable materials to surfaces and components found in automotive, aerospace, and marine vehicles.

U.S. Pat. No. 4,120,913 relates to a composition, which is suitable for use as an adhesive and is made by mixing: (A) liquid epoxy resin and a stoichiometric excess of aromatic amine and (B) a reactive solid epoxy resin powder having an average particle size of from about 10 microns to about 420 microns, the mixture being capable of melting at temperatures of over about 60 DEG C.; wherein solid epoxy (B) is mixed with a liquid mixture of epoxy-amine (A) the components of (A) form a solid reaction product adduct after addition of epoxy (B), the epoxy of (B) remains unreacted until melting of the composition, and the weight ratio of solid epoxy resin:adduct is from about 1 to 6:1.

GB 2 455 292 A discloses means for joining two surfaces that comprise providing a heat activated sealant at the end of one of the surfaces and inserting the end into a C or U shaped cup in the end of the other surface and heating to cause the sealant to flow and join the surfaces. Preferably the sealant is foamable. The sealant is particularly useful in the production of automobile hem flanges.

WO 2004/076507 relates to a reactive hot melt composition in the form of free-flowing pellets. The composition comprises from 37 to 60% based on the total weight of the composition of a cross-linkable resin including at least one copolymer of ethylene with an ethylenically unsaturated monomer and wherein the cross-linkable resin includes an ethylene-acrylic acid or ethylene-methacrylic acid copolymer, from 10 to 30% based on the total weight of the composition of an adhesion promoter, which is a plasticiser and/or a tackifier, for providing adhesive formulation properties to the composition at temperatures of from 50 to 100° C., from 0.5 to 3% based on the total weight of the composition of a free radical cross-linking initiator having a 1 hour half-life temperature of from 110 to 170° C.; from 10 to 40% based on the total weight of the composition of a filler and from 0.1 to 4% based on the total weight of the composition of a foaming agent.

WO 2007/025007 relates to compositions useful as adhesives and more particularly to the preparation of heat-cured epoxy-based adhesive compositions with improved impact resistance and good adhesion to oily metal substrates.

WO 2007/143646 discloses an expandable, thermally curable compositions containing at least one epoxy resin, at least one polyester, at least one blowing agent, and at least one curing agent, which are useful as adhesives and structural reinforcement materials.

WO 2012/041513 discloses a foamable adhesive formulation system which can achieve necessary adhesion to an oily surface and which is not tacky to the touch once applied to the surface and has a melt viscosity in the bake phase high enough to retain its shape and adhesion to the substrate and in addition a melt viscosity sufficiently high to retain gas bubbles formed by the decomposition of the blowing agent and which also retains its shape and structure once formed by use of a polymer system containing a thixotropic filler and a two compartment (component) cross linking system.

WO 2012/110230 relates to a thermohardenable structural adhesive material that upon curing has an elongation at break of at least 10% and has a glass transition temperature (Tg) of 80° C. or higher and is useful as a structural adhesive in automobiles to reduce the deformation of bonds particularly during accidents, the adhesive is dry to the touch at ambient temperature and can be melt processed at temperature below that at which thermohardening occurs.

WO 2013/160878 relates to methods and apparatuses for applying activatable melt flowable materials to substrates made from synthetic materials. The methods are concerned with formation of appropriate flowable materials, control over the manner in which the flowable materials are applied, treatment of the substrates prior to application of the flowable materials and the selection of the optimum combination of materials for the substrates and the flowable materials. The methods may be particularly suited for applying flowable materials to surfaces to produce components found in automotive, aerospace including trucks, busses and tractors and marine vehicles.

WO 2015/011686 relates to flexible films of thermosetting structural adhesive formulations which are non-tacky to the touch, storage stable at room temperature and can be cured at elevated temperature with a short cure time and can be cured to produce a tough flexible adhesive formulation layer including bonding to oily surfaces. The materials are particularly useful in bonding together dissimilar substrates.

It is known to apply activatable structural adhesive formulations to a substrate so that the structural adhesive formulation once applied may be activated at elevated temperature to cure, foam or a combination of both. The structural adhesive formulations may be applied in pumpable form as a paste but they suffer from the disadvantage that they remain tacky to the touch at ambient temperature requiring special handling techniques for the substrate carrying the activatable structural adhesive formulation. It is also known to extrude activatable structural adhesive formulations onto substrates. However extruders are expensive leading to high equipment costs which are not justified for low volume production runs for example in the production of materials for use in the manufacture of trucks or busses or railroad vehicles.

Where structural adhesive formulations are applied manually they are usually applied as a paste which leads to inaccurate definition in the bead line and the need to use larger amounts of structural adhesive formulation in order to be sure to obtain the desired bond. Hot melt guns are known and have been used for applying thermoplastics but have not been proposed for the application of molten heat expandable structural adhesive formulations that may be activated for the production of volumetrically expanded structural adhesive formulations since the heat involved in processing the melt of the structural adhesive formulation within the gun could cause premature foaming and/or curing of the structural adhesive formulation.

There is a demand for structural adhesive formulations that are heat activatable (heat expandable) and that can be applied to various substrates under conditions that prevent premature activation and that can subsequently be activated under various activation conditions that are realized for other reasons in the course of the manufacture of assembled articles, automobiles and other vehicles, e.g. during automotive anticorrosion coating in bake ovens (e.g. bodyshop bakes or paintshop bakes).

It is an object of the invention to provide structural adhesive formulations that have advantages compared to the structural adhesive formulations of the prior art.

This object has been achieved by the subject-matter of the patent claims.

A first aspect of the invention relates to a structural adhesive formulation, which is preferably particulate, which is
heat activatable at a heat activation temperature;
meltable without heat activation at an application temperature above its melting point and below the heat activation temperature; and
solid and dry to the touch at ambient temperature;
   wherein prior to heat activation the structural adhesive formulation preferably has a melt viscosity at 90° C. of about 600±595 Pa·s, preferably within the range of from 10 mPa·s to 1000 mPa·s;
   wherein upon heat activation the structural adhesive formulation is capable of expansion with a volumetric expansion of up to about 250 vol.-%, preferably within the range of from 50 vol.-% and 150 vol.-%;
   wherein after heat activation at the heat activation temperature and cooling down to ambient temperature the structural adhesive formulation preferably has a lap shear resistance of about 12±7 MPa, more preferably within the range of from 8 MPa to 15 MPa, and/or a glass transition temperature of at least about 70° C. a glass transition temperature of at least about 70° C., more preferably at least about 90° C.;
   wherein the heat activatable structural adhesive formulation comprises or essentially consists of
   (a) an epoxy resin component;
   (b) an adhesion promoter component;
   (c) a cross-linking component;
   (d) a blowing component;
   (e) optionally, an impact modifier component;
   (f) optionally, a thixotropic filler component; and
   (g) optionally, a non-thixotropic filler component.

Unless expressly stated otherwise, ambient temperature means a temperature of about 23° C.

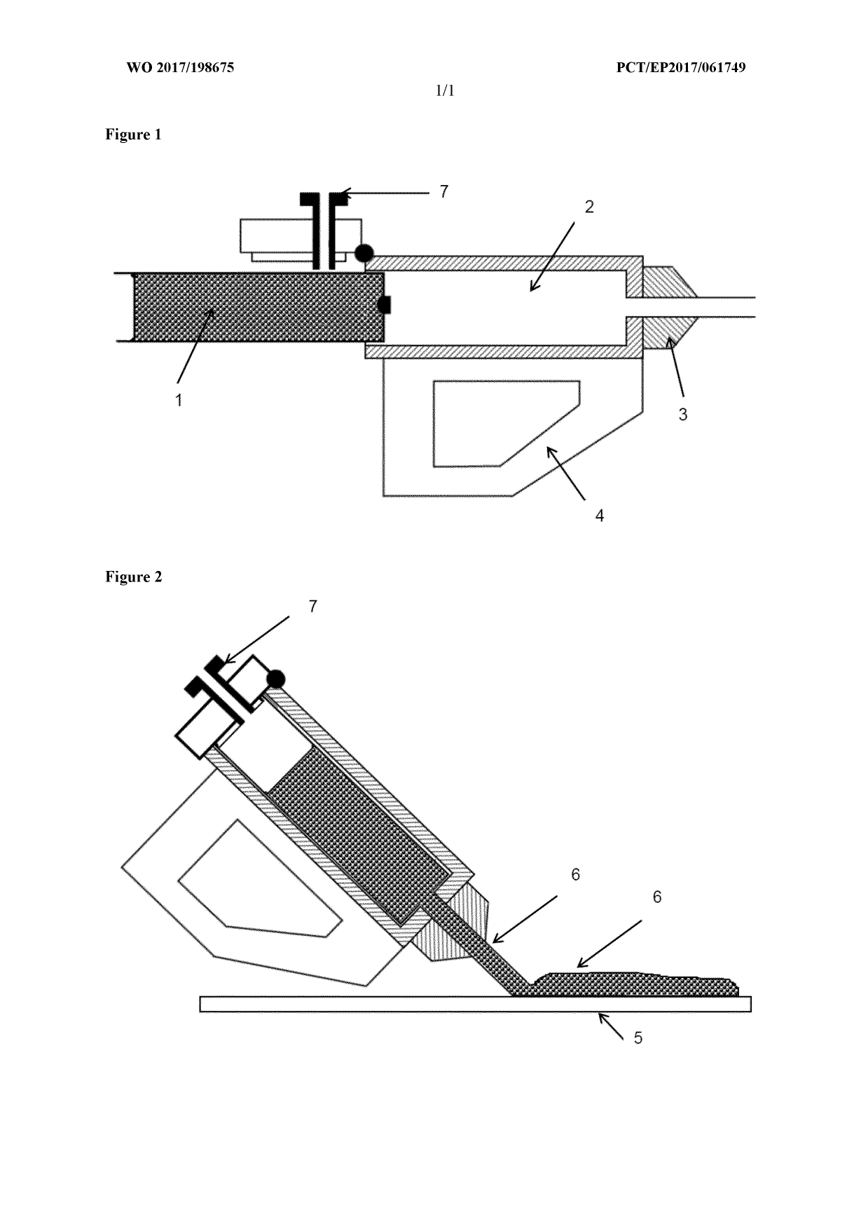

FIGS. 1 and 2 schematically illustrate a hand held hot melt gun. During its use in accordance with the invention, the material (1) is fed to the barrel (2) of the hot melt gun provided with a handle (4). It is then delivered from the nozzle (3) of the hot melt gun (1) onto a surface (5) as a continuous bead (6) by applying pressure from the plunger (7) as is shown in FIG. 2.

The structural adhesive formulation according to the invention is solid under ambient conditions (non sagging, dry to the touch). Conventional adhesives that are solid under ambient conditions do not adhere to cold degreased metal surfaces. The structural adhesive formulation according to the invention overcomes this disadvantage of conventional adhesives. It has been unexpectedly found that the structural adhesive formulation according to the invention achieves good adhesion even to oily surfaces at temperatures below the heat activation temperature, which adhesion is maintained after cooling to ambient temperature. Thus, the non-activated structural adhesive formulation according to the invention may be applied in a non-activated state to metal surfaces, even to oily metal surfaces, and may subsequently be shipped before it is heat activated, possibly after a different location. As the structural adhesive formulation is dry to the touch at ambient temperature, the substrates, e.g. metal substrates, that are applied with the structural adhesive formulation according to the invention may even be stacked without adhering to one another. Furthermore, the non-activated structural adhesive formulation according to the invention may be applied in a non-activated state to metal surfaces, even to oily metal surfaces, with an adhesiveness that is sufficient to withstand and resist to wash out.

In preferred embodiments of the invention, the structural adhesive formulation comprises or essentially consists of components (a), (b), (c), (d), and (e); or components (a), (b), (c), (d), and (f); or components (a), (b), (c), (d), and (g); or components (a), (b), (c), (d), (e) and (f); or components (a), (b), (c), (d), (e) and (g); or components (a), (b), (c), (d), (f) and (g); or components (a), (b), (c), (d), (e), (f) and (g).

The invention provides a simple economic process for the deposition of an structural adhesive formulation without activation and followed by curing and expansion of the deposited structural adhesive formulation by heat. The structural adhesive formulation once deposited on a substrate is dry and non-tacky to the touch and furthermore the structural adhesive formulation can be solvent free and so avoid the formation of volatile organic compounds.

For the purpose of the specification, a material is preferably considered to be non-tacky to the touch if it does not need a force more than 2 N to pull out a 25 mm diameter stainless steel plate applied on its surface.

For the purpose of the specification, dry to the touch preferably means that when a surface of the material is dusted with talcum powder and the talcum powder can be removed by light rubbing without causing the surface to become dull.

For the purpose of the specification, ambient temperature preferably means 21° C.

The structural adhesive formulation has an activation cycle whereby curing and foaming can be accomplished at a later activation stage, perhaps at a different location.

One particular use of the structural adhesive formulation according to the invention is on automobile components, where the structural adhesive formulation is used to foam and adhere to the components to produce seals and optionally also sound absorbing materials between components. The structural adhesive formulation is foamed and cured e.g. by the heat in the baking oven for the anticorrosion coat (e-coat) that is applied to the metal body of the automobile during assembly. In this embodiment it is important that the components provided with the structural adhesive formulation are stackable and can be transported prior to assembly without activation of the structural adhesive formulation and that they are not subject to any conditions prior to or during deposition of the structural adhesive formulation or storage and transportation that impacts the ability of the structural adhesive formulation to expand and optionally cure under the conditions in the baking oven.

The structural adhesive formulation according to the invention is preferably for providing a coherent bead of the structural adhesive formulation onto a substrate by means of a hot melt applicator, wherein the coherent bead adheres to the substrate at the application temperature and is dry to the touch on cooling to ambient temperature, and wherein upon heat activation at the activation temperature the structural adhesive formulation is capable of cross-linking (curing) and volumetric expanding.

If an structural adhesive formulation is to be activated after deposition on a substrate, perhaps some considerable time after deposition on the substrate, it is important that there is no premature activation of the structural adhesive formulation during preparation of the structural adhesive formulation or during application of the structural adhesive formulation to the substrate. Particular difficulties arise if the structural adhesive formulation is heat activated after application and also needs to be heated during application.

The present invention provides the delivery of a heat curable and foamable structural adhesive formulation on a substrate by a preferably hand held hot melt applicator, preferably by a hand held hot melt gun, followed by the expansion and curing of the structural adhesive formulation. Application of the structural adhesive formulation takes place under conditions where foaming and curing do not take place. Foaming and curing takes place after application in a subsequent step when the applied heat activatable structural adhesive formulation is heat activated. The invention further provides an structural adhesive formulation that is used in such a delivery method together with the use of the structural adhesive formulation in such delivery.

The present invention therefore provides a process for the application of a heat activatable structural adhesive formulation to a substrate wherein the heat activatable structural adhesive formulation is solid at ambient temperature and can be melted at a temperature below its heat activation temperature, wherein a preferably particulate heat activatable structural adhesive formulation is supplied to a preferably hand held hot melt applicator, preferably by a hand held hot melt gun, wherein the heat activatable structural adhesive formulation is heated to above its melting point and below its activation temperature and the melt viscosity of the molten structural adhesive formulation is controlled whereby the molten structural adhesive formulation can be or is ejected from the hot melt applicator onto a substrate to provide a coherent bead that adheres to the substrate and is dry to the touch on cooling.

The invention allows the precise application of beads of a thermally activatable structural adhesive formulation which are heat curable and heat foamable at temperatures below that at which they are activated. Subsequent thermal activation may be foaming and crosslinking (curing).

In order to foam under the action of heat the structural adhesive formulation contains a blowing component which generates the gas required to cause foaming at an activation temperature. The techniques of the present invention deliver the structural adhesive formulation onto the substrate at a temperature at which it will adhere to the substrate but which is below that at which the blowing component is activated.

Similarly, the structural adhesive formulation is thermohardenable and hardening is caused by the activation of a curing agent within the structural adhesive formulation. The techniques of the present invention deliver the material at a temperature at which it will adhere to a substrate but which is below that at which the curing agent is activated.

The invention is therefore particularly useful for the provisions of a pattern or array particularly a continuous bead of a structural adhesive formulation on a substrate for subsequent activation. The desired pattern or array of the structural adhesive formulation can be applied according to this invention in an unfoamed and uncured state ready for foaming and curing during the subsequent automotive assembly operation. The techniques are equally useful in other industries such as aircraft, railroad vehicles, furniture and the construction industry.

With the structural adhesive formulation that is applied in accordance with the invention it is possible to reach high volume expansion (e.g. 500% and more) in order to allow filling large cavities and gaps thus achieving improved acoustic damping properties. The expanded structural adhesive formulation provides improved body acoustic, anti-flutter and sealing properties and good corrosion resistance. The structural adhesive formulation in its green state (i.e. prior to heat activation but after melt application) has good green strength adhesion, particularly to degreased cold metal, thereby providing the applied bead to resist wash out. Further, on cooling the applied bead is dry to the touch. It is possible to apply the molten structural adhesive formulation to metal substrates without preheating of substrates.

The structural adhesive formulation according to the invention is heat activatable at a heat activation temperature; meltable without heat activation at an application temperature above its melting point and below the heat activation temperature; and solid and dry to the touch at ambient temperature. Preferably, the structural adhesive formulation according to the invention is dry to the touch at ambient temperature; and/or adherent to a substrate at the application temperature but again dry to the touch after cooling.

Upon heat activation the structural adhesive formulation according to the invention is capable of expansion with a volumetric expansion of up to about 250 vol.-%, preferably within the range of from 50 vol.-% and 150 vol.-%.

Preferably, the structural adhesive formulation according to the invention has a range of volumetric expansion of about 100±95 vol.-%, more preferably 100±90 vol.-%, still more preferably 100±85 vol.-%, yet more preferably 100±80 vol.-%, even more preferably 100±75 vol.-%, most preferably 100±70 vol.-% and in particular 100±65 vol.-%.

The level of expansion depends upon the nature and the amount of blowing agent that is contained in the structural adhesive formulation and can be determined by simple routine testing. The level of expansion can also be influenced by the optional presence of a blowing agent accelerator.

The structural adhesive formulation delivered to the hot melt applicator, preferably by a hand held hot melt gun, according to this invention may be in form of pellets, micro-pellets or may be powdered. Alternatively, the material may be in form of a bulk material, i.e. a mass that may be congealed and/or monolithic and provided e.g. in a cartridge. For the purpose of the specification, the term “particulate” preferably also encompasses a bulk material such as a solid monolithic congealed mass.

Preferably, the structural adhesive formulation according to the invention is particulate. Preferably, the structural adhesive formulation according to claim 2, which is in the form of a powder with an average particle size of from about 20 μm to about 250 μm; or from about 250 μm to about 1000 μm, or from about 1000 μm to about 6000 μm.

When the structural adhesive formulation according to the invention is in powder form, it may have an average particle size within the range of from about 20 μm to about 250 μm, preferably of at least about 20 μm, and less than about 200 μm, preferably having an average particle size of at least about 25 μm and less than about 125 μm. The powdered structural adhesive formulation may be obtained by grinding pellets of the structural adhesive formulation until they will pass through an appropriate sized mesh.

Alternatively, when the structural adhesive formulation according to the invention is in the form of micro-pellets, the micro-pellets preferably have an average particle size of from about 250 μm to about 1000 μm, or about 250 μm to about 750 μm, more preferably about 300 μm to about 1000 μm, or about 300 μm to about 750 μm.

Alternatively, when the structural adhesive formulation according to the invention is in the form of pellets, the pellets preferably have an average particle size of from about 1000 μm to about 6000 μm, or preferably from about 1000 μm to about 5000 μm, more preferably from about 3000 μm to about 6000 μm, or from about 3000 μm to about 5000 μm.

Suitable methods to measure the average particle size are known to the skilled artisan and include laser diffraction and image analysis. Preferably, for the purpose of the specification, the “average particle size” is expressed in terms of the geometric mean value D[4,3] with the volume as the basis for the distribution calculation (volume distribution) in accordance with ASTM E 799. In a preferred embodiment, the particle size is measured using a laser particle size meter, preferably with the powder dispersed in deionized water.

Preferably, the structural adhesive formulation according to the invention after heat activation at the heat activation temperature and cooling down to ambient temperature has a lap shear resistance of about 12±7 MPa, preferably within the range of from 8 MPa to 15 MPa. In preferred embodiments, the lap shear resistance is about 12±7 MPa, more preferably 12±6 MPa, still more preferably 12±5 MPa, and most preferably 12±4 MPa. The lap shear strengths of the cured structural adhesive formulation layers are determinable according to ASTM D1002-01.

Preferably, the structural adhesive formulation according to the invention after heat activation at the heat activation temperature and cooling down to ambient temperature has a glass transition temperature of at least 70° C., preferably at least 90° C. Preferably, the glass transition temperature is determined by differential scanning calorimetry (preferably in accordance with ASTM E1356-08(2014)), e.g. by means of a device Mettler Toledo 822e at a heating rate of 10° C./min up to 180° C. on 5 mg samples. The measured values are determined by means of the DSC software from the measured DSC curve.

Preferably, the structural adhesive formulation according to the invention after heat activation at the heat activation temperature and cooling down to ambient temperature has a relatively high impact resistance, can exhibit desirable toughness and/or T-peel strengths. As an example, the T-peel strengths according to ASTM D 1876-01 is preferably at least about 2 N/mm, more preferably at least about 3.7 N/mm or even at least about 5.5 N/mm.

Preferably, the structural adhesive formulation according to the invention has a melt viscosity at 90° C. (preferably in accordance with ASTM D3236-15) of about 600±595 Pa·s, preferably within the range of from 10 mPa·s to 1000 mPa·s. In preferred embodiments, the melt viscosity at 90° C. is about 200±150 mPa·s, or about 200±100 mPa·s, or about 200±50 mPa·s, about 300±150 mPa·s, or about 300±100 mPa·s, or about 300±50 mPa·s, about 400±150 mPa·s, or about 400±100 mPa·s, or about 400±50 mPa·s, about 500±150 mPa·s, or about 500±100 mPa·s, or about 500±50 mPa·s, about 600±150 mPa·s, or about 600±100 mPa·s, or about 600±50 mPa·s, about 700±150 mPa·s, or about 700±100 mPa·s, or about 700±50 mPa·s, about 800±150 mPa·s, or about 800±100 mPa·s, or about 800±50 mPa·s, about 900±150 mPa·s, or about 900±100 mPa·s, or about 900±50 mPa·s.

As the structural adhesive formulation according to the invention is preferably applied to a preferably cold surface of a substrate by means of a mot melt applicator which is preferably equipped neither with a pump nor with a screw, the melt viscosity of the structural adhesive formulation according to the invention is substantially below that of conventional structural adhesive formulations that are to be applied by means of an extruder. It has been unexpectedly found that structural adhesive formulations can be prepared on the one hand having a melt viscosity that is low enough so that adhesive can be processed at a temperature below the heat activation temperature and on the other hand keeping a dry to the touch behavior after the application to a substrate and before heat activation.

It has been found that these above desired properties of the structural adhesive formulation according to the invention can be adjusted by the composition of the adhesion promoter component (e.g. by employing hydrocarbon resins at relatively high weight contents), of the epoxy resin component (e.g. by employing a mixture of solid and liquid epoxy resins), by several rheological modifiers (e.g. by employing a thixotropic filler component and/or aramid fibers), and optionally by other components such as the impact modifier component comprising rubbers in comparatively small amounts in order to improve tackiness.

The structural adhesive formulation comprises (a) an epoxy resin component. Preferably, the epoxy resin component is heat curable, i.e. capable of cross-linking at elevated temperatures.

Preferably, the epoxy resin component comprises or essentially consists of
(a₁) one or more diglycidylethers of bisphenol (component (a₁)) wherein the bisphenol is preferably selected from the group consisting of bisphenol A, bisphenol AF, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, and bisphenol Z, e.g. bisphenol A diglycidylether (DGEBA) and/or bisphenol F diglycidylether (DGEBF); and/or
(a₂) one or more resins obtainable by reacting a composition comprising formaldehyde and an aromatic alcohol (component (a₂)), wherein the aromatic alcohol is selected from the group consisting of phenol (phenol novolac resin), cresol (cresol novolac resin), and resorcinol (resorcinol resin), e.g. a phenol novolac resin and/or a cresol novolac resin and/or a resorcinol resin; and/or
(a₃) one or more resins obtainable by reacting a composition comprising epichlorohydrin and an aromatic dialcohol (phenoxy resin) (component (a₃)), preferably wherein the aromatic dialcohol is a bisphenol, wherein the bisphenol is preferably selected from the group consisting of bisphenol A, bisphenol AF, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, and bisphenol Z, e.g. poly(bisphenol A-co-epichlorohydrin) or poly(bisphenol F-co-epichlorohydrin); and/or
(a₄) one or more resins obtainable by reacting a composition comprising epichlorohydrin and an cycloaliphatic dialcohol (cycloaliphatic resin) (component (a₄)), preferably a cycloaliphatic epoxy resin.

In preferred embodiments of the invention, the epoxy resin component comprises or essentially consists of component (a₁); or component (a₂); or component (a₃); or component (a₄); or components (a₁) and (a₂); or components (a₁) and (a₃); or components (a₁) and (a₄); or components (a₂) and (a₃); or components (a₂) and (a₄); or components (a₃) and (a₄); or components (a₁) and (a₂) and (a₃); or components (a₁) and (a₂) and (a₄); or components (a₁) and (a₃) and (a₄); or components (a₂) and (a₃) and (a₄); or components (a₁) and (a₂) and (a₃) and (a₄).

Preferably, the weight content of the epoxy resin component, relative to the total weight of the structural adhesive formulation, is about 22.5±12.5 wt.-%, more preferably about 22.5±10 wt.-%, still more preferably about 22.5±9.0 wt.-%, yet more preferably about 22.5±8.0 wt.-%, even more preferably about 22.5±7.0 wt.-%, most preferably about 22.5±6.0 wt.-%, and in particular about 22.5±5.0 wt.-%.

In a preferred embodiment of the invention, component (a₁) of the epoxy resin component comprises or essentially consists of bisphenol A diglycidylether (DGEBA); or bisphenol F diglycidylether (DGEBF); or bisphenol A diglycidylether (DGEBA) and bisphenol F diglycidylether (DGEBF).

Preferably, the weight content of component (a₁) (e.g. DGEBA and/or DGEBF), relative to the total weight of the structural adhesive formulation, is about 12.0±11.5 wt.-%, more preferably about 12±11 wt.-%, still more preferably about 12±10 wt.-%, yet more preferably about 12±9 wt.-%, even more preferably about 12±8 wt.-%, most preferably about 12±7 wt.-%, and in particular about 12±6 wt.-%. Preferably, the weight content of component (a₁), relative to the total weight of the structural adhesive formulation, is about 6.0±5.5 wt.-%, more preferably about 6.0±5.0 wt.-%, still more preferably about 6.0±4.5 wt.-%, yet more preferably about 6.0±4.0 wt.-%, even more preferably about 6.0±3.5 wt.-%, most preferably about 6.0±3.0 wt.-%, and in particular about 6.0±2.5 wt.-%. Preferably, the weight content of component (a₁), relative to the total weight of the structural adhesive formulation, is about 3.0±2.8 wt.-%, more preferably about 3.0±2.5 wt.-%, still more preferably about 3.0±2.3 wt.-%, yet more preferably about 3.0±2.1 wt.-%, even more preferably about 3.0±1.9 wt.-%, most preferably about 3.0±1.7 wt.-%, and in particular about 3.0±1.5 wt.-%.

In preferred embodiments of the invention, component (a₂) of the epoxy resin component comprises or essentially consists of a cresol novolac resin; or a phenol novolac resin; or a resorcinol resin; or a cresol novolac resin and a phenol novolac resin; or a cresol novolac resin and a resorcinol resin; or a phenol novolac resin and a resorcinol resin; or a cresol novolac resin and a phenol novolac resin and a resorcinol resin.

Preferably, the weight content of component (a₂) (e.g. cresol novolac resin and/or phenol novolac resin and/or resorcinol resin), relative to the total weight of the structural adhesive formulation, is about 12.0±11.5 wt.-%, more preferably about 12±11 wt.-%, still more preferably about 12±10 wt.-%, yet more preferably about 12±9 wt.-%, even more preferably about 12±8 wt.-%, most preferably about 12±7 wt.-%, and in particular about 12±6 wt.-%. Preferably, the weight content of component (a₂), relative to the total weight of the structural adhesive formulation, is about 6.0±5.5 wt.-%, more preferably about 6.0±5.0 wt.-%, still more preferably about 6.0±4.5 wt.-%, yet more preferably about 6.0±4.0 wt.-%, even more preferably about 6.0±3.5 wt.-%, most preferably about 6.0±3.0 wt.-%, and in particular about 6.0±2.5 wt.-%. Preferably, the weight content of component (a₂), relative to the total weight of the structural adhesive formulation, is about 3.0±2.8 wt.-%, more preferably about 3.0±2.5 wt.-%, still more preferably about 3.0±2.3 wt.-%, yet more preferably about 3.0±2.1 wt.-%, even more preferably about 3.0±1.9 wt.-%, most preferably about 3.0±1.7 wt.-%, and in particular about 3.0±1.5 wt.-%.

Preferably, the phenoxy resin (component (a3)) can be regarded as the condensation products of
a bisphenol, preferably being selected from the group consisting of bisphenol A, bisphenol B, bisphenol E, bisphenol F, bisphenol G, bisphenol M, bisphenol P, bisphenol S, bisphenol Z, bisphenol AF, bisphenol AP, bisphenol BP, bisphenol FL, and bisphenol TMC; and
epichlorohydrin;
   or a blend of various resins of this type and/or their derivatives.

Preferred phenoxy resins include low molecular weight, medium molecular weight, or high molecular weight materials which typically have a melting point around about 150° C. or higher. As one important use of the powders of this invention is in the production of adhesive bonds by the curing of the layers obtained on the surface of the substrate from the powders at temperatures experienced in the automobile e-coat process, it is preferred to formulate the formulation from which the powder is made at temperatures below the melting point of the phenoxy resin. Accordingly it is preferred that the phenoxy resin be provided to the formulating activity as a solution. It has been unexpectedly found that a liquid epoxy based material is a particularly good solvent for the phenoxy resin.

Preferred phenoxy resins are low molecular weight, medium molecular weight, or high molecular weight thermoplastic condensation products of bisphenol, preferably bisphenol A, and epichlorohydrin and their derivatives. Typically the phenoxy resins that may be employed are of the formula

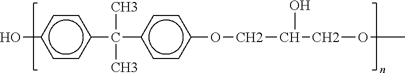

where n is typically
from about 2 to about 12, preferably 2, 3, 4, 5, 6, 7, 8, 9, 10, 11 or 12; or
from about 13 to about 29; or
from about 30 to about 100, preferably from about 50 to about 90.

Modified phenoxy resins may also be used. Examples of phenoxy resins that may be used are the products marketed by Inchem Corp. Examples of suitable materials are the PKHB, PKHC, PKHH, PKHJ, PKHP pellets and powder. Alternatively phenoxy/polyester hybrids and epoxy/phenoxy hybrids may be used. In order to enhance the production of the structural adhesive formulation the phenoxy resin may be supplied to the other components as a solution. While any solvent may be used it is particularly preferred to use a liquid epoxy based material as the solvent as this can also contribute to the structural adhesive formulation properties upon activation.

Preferably, the weight content of component (a₃) (e.g. phenoxy resin), relative to the total weight of the structural adhesive formulation, is about 12.0±11.5 wt.-%, more preferably about 12±11 wt.-%, still more preferably about 12±10 wt.-%, yet more preferably about 12±9 wt.-%, even more preferably about 12±8 wt.-%, most preferably about 12±7 wt.-%, and in particular about 12±6 wt.-%. Preferably, the weight content of component (a₃), relative to the total weight of the structural adhesive formulation, is about 6.0±5.5 wt.-%, more preferably about 6.0±5.0 wt.-%, still more preferably about 6.0±4.5 wt.-%, yet more preferably about 6.0±4.0 wt.-%, even more preferably about 6.0±3.5 wt.-%, most preferably about 6.0±3.0 wt.-%, and in particular about 6.0±2.5 wt.-%. Preferably, the weight content of component (a₃), relative to the total weight of the structural adhesive formulation, is about 3.0±2.8 wt.-%, more preferably about 3.0±2.5 wt.-%, still more preferably about 3.0±2.3 wt.-%, yet more preferably about 3.0±2.1 wt.-%, even more preferably about 3.0±1.9 wt.-%, most preferably about 3.0±1.7 wt.-%, and in particular about 3.0±1.5 wt.-%.

Preferably, the weight content of component (a₄) (e.g. cycloaliphatic resin), relative to the total weight of the structural adhesive formulation, is about 12.0±11.5 wt.-%, more preferably about 12±11 wt.-%, still more preferably about 12±10 wt.-%, yet more preferably about 12±9 wt.-%, even more preferably about 12±8 wt.-%, most preferably about 12±7 wt.-%, and in particular about 12±6 wt.-%. Preferably, the weight content of component (a₄), relative to the total weight of the structural adhesive formulation, is about 6.0±5.5 wt.-%, more preferably about 6.0±5.0 wt.-%, still more preferably about 6.0±4.5 wt.-%, yet more preferably about 6.0±4.0 wt.-%, even more preferably about 6.0±3.5 wt.-%, most preferably about 6.0±3.0 wt.-%, and in particular about 6.0±2.5 wt.-%. Preferably, the weight content of component (a₄), relative to the total weight of the structural adhesive formulation, is about 3.0±2.8 wt.-%, more preferably about 3.0±2.5 wt.-%, still more preferably about 3.0±2.3 wt.-%, yet more preferably about 3.0±2.1 wt.-%, even more preferably about 3.0±1.9 wt.-%, most preferably about 3.0±1.7 wt.-%, and in particular about 3.0±1.5 wt.-%.

The structural adhesive formulation comprises (b) an adhesion promoter component.

Preferably, the adhesion promoter component comprises or essentially consists of one or more tackifiers selected from the group consisting of rosin resins, hydrocarbon resins, and terpene resins. Such tackifiers are commercially available.

Preferred tackifiers include but are not limited to aromatic hydrocarbon resins, aliphatic hydrocarbon resins, aliphatic aromatic hydrocarbon resins, rosin resins, inden-coumaron resins, and polymers of cycloaliphatic resins and alkyl aromatic resins.

Rosin resins are derived from either aged tree stumps (wood rosin), sap (gum rosin), or by-products of the paper making process (tall oil rosin).

Hydrocarbon resins are made from petroleum based feedstocks either aliphatic (C5), aromatic (C9), DCPD (dicyclopentadiene), or mixtures of these.

Terpene Resins are derived from terpene feedstocks either from wood sources or from citrus fruit.

In a preferred embodiment, the adhesion promoter component comprises a hydrocarbon resin made from aliphatic (C5) petroleum based feedstock, preferably at a weight content within the range of about 15±10 wt.-%, more preferably about 15±5 wt.-%, relative to the total weight of the structural adhesive formulation.

In another preferred embodiment, the adhesion promoter component comprises a hydrocarbon resin made from aromatic (C9) petroleum based feedstock, preferably at a weight content within the range of about 15±10 wt.-%, more preferably about 15±5 wt.-%, relative to the total weight of the structural adhesive formulation.

In still another preferred embodiment, the adhesion promoter component comprises a hydrocarbon resin made from DCPD (dicyclopentadiene) petroleum based feedstock, preferably at a weight content within the range of about 15±10 wt.-%, more preferably about 15±5 wt.-%, relative to the total weight of the structural adhesive formulation.

In preferred embodiments, the adhesion promoter component comprises a hydrocarbon resin made from a mixture of petroleum based feedstocks, wherein said mixture comprises aliphatic (C5) petroleum based feedstock and aromatic (C9) petroleum based feedstock; or aliphatic (C5) petroleum based feedstock and DCPD (dicyclopentadiene) petroleum based feedstock; or aromatic (C9) petroleum based feedstock and DCPD (dicyclopentadiene) petroleum based feedstock; or aliphatic (C5) petroleum based feedstock, aromatic (C9) petroleum based feedstock, and DCPD (dicyclopentadiene) petroleum based feedstock; in each case preferably at a weight content within the range of about 15±10 wt.-%, more preferably about 15±5 wt.-%, relative to the total weight of the structural adhesive formulation.

In a preferred embodiment, the weight content of the adhesion promoter component, relative to the total weight of the structural adhesive formulation, is about 12.5±12.4 wt.-%, more preferably about 12.5±12 wt.-%, still more preferably about 12.5±11 wt.-%, yet more preferably about 12.5±10 wt.-%, even more preferably about 12.5±9 wt.-%, most preferably about 12.5±8 wt.-%, and in particular about 12.5±7 wt.-%.

In another preferred embodiment, the weight content of the adhesion promoter component, relative to the total weight of the structural adhesive formulation, is about 15±14 wt.-%, more preferably about 15±12 wt.-%, still more preferably about 15±10 wt.-%, yet more preferably about 15±8 wt.-%, even more preferably about 15±6 wt.-%, most preferably about 15±5 wt.-%, and in particular about 15±4 wt.-%.

It has been found that adhesion of the structural adhesive formulation to various substrates including metal substrates and even oily metal substrates may be improved by the presence of hydrocarbon resins at relatively high weight contents. In particular, by choosing a hydrocarbon resin having the right polarity, it is possible to achieve a good adhesion of the uncured structural adhesive formulation to oily surfaces maintaining a good compatibility with the epoxy resin component.

Convenient methods to characterize resin compatibility are known to the skilled person, e.g. determination of cloud points in suitable solvent systems. Cloud point values determine whether the resin is aliphatic, aromatic, or a combination of both; polar or nonpolar; with a high or low molecular weight. Cloud points may be related to compatibility as follows: Mixed Methylcyclohexane-Aniline Point (MMAP) is a measurement of aromatic solubility and determines the aliphatic/aromatic character of the resin using a solvent blend of a 1:2 mixture of methylcyclohexane and aniline. Low MMAP values (<40° C.) typify highly aromatic tackifier resins. High MMAP values (>75° C.) indicate a resin is fully aliphatic and/or hydrogenated. Diacetone Alcohol Cloud Point (DACP) determines the polarity of the resin due to the highly polar nature of the solvent system of a 1:1 mixture of xylene and 4-hydroxy-4-methyl-2-pentanone (common name: diacetone alcohol). Since specific adhesion is related to the polarity of a resin, the DACP cloud point can be used as a specific adhesion indicator. A low DACP value, for example, would indicate a polar tackifier with high specific adhesion to polar substrates such as polyester, aluminum, or galvanized steel. Odorless Mineral Spirit (OMS) determination is only meaningful for aromatic resins dissolved in odorless mineral spirits, a mixture of various aliphatic mineral solvents. Because aliphatic resin types give OMS values lower than −30° C. (−22° F.), the method is not useful for non-aromatic resins since most laboratories are not equipped to operate at such low temperatures. The OMS value determines molecular weight and molecular weight distribution. In addition, OMS can determine compatibility characteristics of a resin/polymer system, especially for ethylene-vinyl acetate (EVA) polymers. For any one generic type of resin, the higher the OMS cloud point, the greater the molecular weight and the molecular weight distribution. In particular, high OMS values can indicate the presence of high molecular weight material (Mz). Cloud points are a practical and efficient way to get an indication of the compatibility between a selected elastomer and tackifier resin; however, the actual compatibility should always be verified by testing such as DMA analysis and adhesive performance.

The structural adhesive formulation comprises (c) a cross-linking component.

Preferably, the cross-linking component comprises one or more curing agents and/or curing agent accelerators. Amounts of curing agents and curing agent accelerators may vary depending upon the type of cure required and cross link density desired and the desired structural properties of cured structural adhesive formulation. The curing agent is a latent curing agent, i.e. is not reactive under ambient conditions but is heat activatable. Preferably, the curing agent contains functional groups that are capable of reacting with the epoxy groups and/or other functional groups of the epoxy resin component at an elevated activation temperature. Preferably, the curing agent has an activation temperature above about 110° C., preferably of about 120° C. or above, more preferably in the range of from about 130° C. to about 220° C., preferably about 150° C. to about 220° C. The curing agents assist the structural adhesive formulation in curing by crosslinking. The curing agents may also assist in thermosetting the structural adhesive formulation.

Useful classes of curing agents are materials selected from aliphatic or aromatic amines or their respective adducts, amidoamines, polyamides, cycloaliphatic amines, or mixtures thereof. The curing agents may include modified and unmodified polyamines or polyamides such as triethylenetetramine, diethylenetriamine tetraethylenepentamine, cyanoguanidine, dicyandiamides and the like. In a particularly preferred embodiment, the curing agent is or comprises dicyandiamide.

An accelerator for the curing agents (e.g., a modified or unmodified urea such as methylene diphenyl bis urea, an imidazole or a combination thereof) may also be provided.

Preferably, the cross-linking component comprises or essentially consists of
(c₁) one or more curing agents selected from the group consisting of aromatic amines (e.g. 4,4′-diaminodiphenyl sulfone (DDS)), imidazole derivatives, unsubstituted dicyandiamide and substituted dicyandiamides; and/or
(c₂) one or more curing accelerators selected from the group consisting of modified ureas, diuron and imidazole.

Preferably, the weight content of the the cross-linking component, relative to the total weight of the structural adhesive formulation, is about 5.0±4.9 wt.-%, more preferably about 5.0±4.5 wt.-%, still more preferably about 5.0±4.0 wt.-%, yet more preferably about 5.0±3.5 wt.-%, even more preferably about 5.0±3.0 wt.-%, most preferably about 5.0±2.5 wt.-%, and in particular about 5.0±2.0 wt.-%.

The structural adhesive formulation comprises (d) a blowing component.

The blowing component is foamable and comprises a heat activatable blowing agent for example one that decomposes to produce gas at temperatures experienced in the automotive anticorrosion coating bake oven. Typically, temperatures are in the range of from about 150° C. to about 220° C. Preferably, the blowing component has an activation temperature of about 120° C. or above.

Preferably, the blowing component comprises or essentially consists of
(d₁) one or more physical blowing agents and/or one or more chemical blowing agents; and/or
(d₂) one or more blowing accelerators.

Preferably, the one or more chemical blowing agents are selected from the group consisting of azo compounds, such azodicarbonamide, azodiisobutyro-nitrile, barium azodicarboxylate, nitroso compounds such as DNPT (dinitroso-pentamethylene-tetramine), N,N′-dimethyl-N,N′-dinitroso-terephthalamide, hydrazides such as benzenesulfonhydrazine, 4,4-oxy-bis-benzenesulfonylhydrazide (OBSH), or p-toluenesulfonyl hydrazine, carbazides such as 4,4-oxybenzene sulfonyl semi carbazide, p-toluene sulfonyl semicarbazide, triazines such as trihydrazino triazine and reactive couples as mixture of citric acid and sodium bicarbonate.

The blowing agent may also be a physical blowing agent, such that material expansion occurs via a phase change mechanism. Physical blowing agents can comprise a volatile gas trapped in a thermoplastic shell which softens and lets the gas expand at the foaming temperature. An example of such a blowing agent in sold under the trade name Expancel, sold by Akzo Nobel, Sundsvall, Sweden.

An accelerator for the blowing agents may also be provided in the activatable material. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles or imidazoles.

Preferably, the weight content of the the blowing component, relative to the total weight of the structural adhesive formulation, is about 5.0±4.9 wt.-%, more preferably about 5.0±4.5 wt.-%, still more preferably about 5.0±4.0 wt.-%, yet more preferably about 5.0±3.5 wt.-%, even more preferably about 5.0±3.0 wt.-%, most preferably about 5.0±2.5 wt.-%, and in particular about 5.0±2.0 wt.-%.

The structural adhesive formulation preferably comprises (e) an impact modifier component.

Preferably, the impact modifier component comprises or essentially consists of an additive based on rubber and/or core shell material. Preferably, the additive based on rubber is selected from reactive liquid rubbers (e.g. acrylonitrile butadiene terminated with carboxyl or amine or vinyl), nitril rubbers, ethylene propylene diene monomer rubber (EPDM rubbers), butyl rubbers, and styrene butadiene rubbers (SBR).

Preferably, the impact modifier component comprises one or more materials selected from elastomer/epoxy adducts, core/shell materials, and combinations thereof.

While it is contemplated that various polymer/elastomer adducts may be employed in the structural adhesive formulation, one preferred adduct is an epoxy/elastomer adduct. The elastomer/epoxy adduct is to be regarded as being separate from the epoxy resin component, i.e. the epoxy resin component does not encompass the elastomer/epoxy adduct. The elastomer-containing adduct may be a combination of two or more particular adducts and the adducts may be solid adducts or liquid adducts at a temperature of about 23° C. or may also be combinations thereof. The adduct is preferably one or more adducts that are solid at a temperature of about 23° C. The adduct itself generally includes about 1:8 to 3:1 parts of epoxy or other polymer to elastomer, and more preferably about 1:5 to 1:6 parts of epoxy to elastomer. More typically, the adduct includes at least about 5 wt.-%, more typically at least about 12 wt.-% and even more typically at least about 18 wt.-% elastomer and also typically includes not greater than about 50 wt.-%, even more typically no greater than about 40 wt.-% and still more typically no greater than about 35 wt.-% elastomer, although higher or lower percentages are possible. The elastomer compound may be a thermosetting elastomer. Exemplary elastomers include, without limitation, natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. An example of a preferred epoxy/elastomer adduct is sold under the trade name HYPDX commercially available from CVC Chemical. Examples of additional or alternative epoxy/elastomer or other adducts suitable for use in the invention are disclosed in US 2004/0204551. The elastomer-containing adduct, when added to the structural adhesive formulation, may modify structural properties of the structural adhesive formulation such as strength, toughness, stiffness, flexural modulus, or the like.

The impact modifier component may include at least one core/shell impact modifier. The impact modifier component may compromise at least about 60 wt.-%, at least about 80 wt.-% or even at least about 95 wt.-% core/shell impact modifier. As used herein, the term core/shell impact modifier denotes an impact modifier wherein a substantial portion (e.g., greater than about 30 wt.-%, about 50 wt.-%, about 70 wt.-% or more) thereof is comprised of a first polymeric material (i.e., the first or core material) that is substantially entirely encapsulated by a second polymeric material (i.e., the second or shell material). The first and second polymeric materials, as used herein, can be comprised of one, two, three or more polymers that are combined and/or reacted together (e.g., sequentially polymerized) or may be part of separate or same core/shell systems. The first and second polymeric materials of the core/shell impact modifier can include elastomers, polymers, thermoplastics, copolymers, other components, combinations thereof or the like. The first polymeric material, the second polymeric material or both of the core/shell impact modifier may include or may be substantially entirely composed of (e.g., at least about 70 wt.-%, about 80 wt.-%, about 90 wt.-% or more) one or more thermoplastics. Exemplary thermoplastics include, without limitation, styrenics, acrylonitriles, acrylates, acetates, polyamides, polyethylenes or the like. Examples of useful core-shell graft copolymers are those where hard containing compounds, such as styrene, acrylonitrile or methyl methacrylate, are grafted onto a core made from polymers of soft or elastomeric containing compounds such as butadiene or butyl acrylate.

The core polymer may also include other copolymerizable containing compounds, such as styrene, vinyl acetate, methyl methacrylate, butadiene, isoprene, or the like. The core polymer material may also include a cross linking monomer having two or more nonconjugated double bonds of approximately equal reactivity such as ethylene glycol diacrylate, butylene glycol dimethacrylate, and the like. The core polymer material may also include a graft linking monomer having two or more nonconjugated double bonds of unequal reactivity such as, for example, diallyl maleate and allyl methacrylate. The shell portion may be polymerized from methyl methacrylate and optionally other alkyl methacrylates, such as ethyl, butyl, or mixtures thereof methacrylates. Additional core-shell graft copolymers useful in embodiments of the invention are described in U.S. Pat. Nos. 3,984,497; 4,096,202; 4,034,013; 3,944,631; 4,306,040; 4,495,324; 4,304,709; 4,536,436; and 7,892,396, the entireties of which are herein incorporated by reference herein. Examples of suitable core-shell graft copolymers include, but are not limited to, “MBS” (methacrylatebutadiene-styrene) polymers, which are made by polymerizing methyl methacrylate in the presence of polybutadiene or a polybutadiene copolymer rubber. The MBS graft copolymer resin generally has a styrene butadiene rubber core and a shell of acrylic polymer or copolymer. Examples of other useful core-shell graft copolymer resins include, ABS (acrylonitrile-butadiene-styrene), MABS (methacrylate-acrylonitrile-butadiene-styrene), ASA (acrylate-styrene-acrylonitrile), all acrylics, SA EPDM (styrene-acrylonitrile grafted onto elastomeric backbones of ethylene-propylene diene monomer), MAS (methacrylic-acrylic rubber styrene), and the like and mixtures thereof.

Preferably, the weight content of the the impact modifier component, relative to the total weight of the structural adhesive formulation, is about 7.5±7.4 wt.-%, more preferably about 7.5±7.0 wt.-%, still more preferably about 7.5±6.0 wt.-%, yet more preferably about 7.5±5.0 wt.-%, even more preferably about 7.5±4.0 wt.-%, most preferably about 7.5±3.0 wt.-%, and in particular about 7.5±2.0 wt.-%.

The structural adhesive formulation preferably comprises (f) a thixotropic filler component.

Preferably, the thixotropic filler component comprises or essentially consists of one or more thixotropic fillers selected from the group consisting of fumed silica, bentonite, quaternary ammonium salts, and aramide fibers (e.g. PAA, PA-MXD-6, PPA, PA MPD-I, PA PPD-T).

Preferably, the weight content of the the thixotropic filler component, relative to the total weight of the structural adhesive formulation, is about 5.0±4.9 wt.-%, more preferably about 5.0±4.5 wt.-%, still more preferably about 5.0±4.0 wt.-%, yet more preferably about 5.0±3.5 wt.-%, even more preferably about 5.0±3.0 wt.-%, most preferably about 5.0±2.5 wt.-%, and in particular about 5.0±2.0 wt.-%.

The inclusion of such a thixotropic filler can reduce the tendency of the structural adhesive formulation to flow and sag when it is a fluid state such as when the structural adhesive formulation forms a film after application or when it is heated to the activation temperature.

The structural adhesive formulation preferably comprises (g) a non-thixotropic filler component.

Suitable fillers include particulated materials (e.g., powder), beads, microspheres, or the like. The precursor layer may also be substantially free of any filler material. Fillers can be useful to reduce any blocking tendency of the uncured powdered heat activatable structural adhesive formulation, reduce cost, and reduce the coefficient of thermal expansion of the cured material. Certain fillers can also reduce the tendency of the particles to agglomerate as well as reducing the blocking tendency.

Examples of suitable fillers include silica, diatomaceous earth, glass, clay (e.g., including nanoclay), talc, pigments, colorants, glass beads or bubbles, glass, carbon or ceramic fibers, nylon aramid or polyamide fibers (e.g., Kevlar), antioxidants, and the like. Such fillers, particularly clays, can assist the activatable material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

Preferably, the non-thixotropic filler component comprises or essentially consists of an inorganic mineral selected from the group consisting of calcium carbonate, magnesium silicate (e.g. talc) and calcium silicate (e.g. wollastonite).

Preferably, the weight content of the the non-thixotropic filler component, relative to the total weight of the structural adhesive formulation, is about 30±29 wt.-%, more preferably about 30±25 wt.-%, still more preferably about 30±21 wt.-%, yet more preferably about 30±17 wt.-%, even more preferably about 30±13 wt.-%, most preferably about 30±9 wt.-%, and in particular about 30±5 wt.-%.

Preferably, the structural adhesive formulation according to the invention
is solid and dry to the touch at ambient temperature;
has a melt viscosity at 90° C. of not more than 1000 mPa·s;
has a heat activation temperature above 150° C.

It has been found that these properties of the structural adhesive formulation according to the invention can be adjusted by the composition of the adhesion promoter component (e.g. by employing hydrocarbon resins at relatively high weight contents), of the epoxy resin component (e.g. by employing a mixture of solid and liquid epoxy resins), by several rheological modifiers (e.g. by employing a thixotropic filler component and/or aramid fibers), and optionally by other components such as the impact modifier component comprising rubbers in comparatively small amounts in order to improve tackiness. The right type and amount of solid epoxy resins, the right type and amount of liquid epoxy resins, as well as the right type and amount of rheology modifiers (such as the impact modifier component) allow for properly adjusting and controlling rheology. The right type and amount of cross-linking component including (latent) curing agent and catalyst allow for properly adjusting and controlling the heat activation temperature in order to provide a structural adhesive formulation that is not reactive, neither under ambient conditions nor under the conditions of melt application to substrates, but at the heat activation temperature. Compared to conventional structural adhesives that are to be applied by means of extruders that structural adhesive formulations according to the invention are distinguished by a different melt viscosity and the fact that the structural adhesive formulations according to the invention adhere even to cold metallic surfaces.

Another aspect of the invention relates to a cartridge for a hot melt applicator, preferably for a hand held hot melt gun, which cartridge comprises the structural adhesive formulation according to the invention as described above.

All preferred embodiments that have been described above in relation to the structural adhesive formulation according to the invention analogously apply to the cartridge according to the invention and thus are not repeated hereinafter.

Another aspect of the invention relates to a process for the application of a heat activatable structural adhesive formulation according to the invention as described above to a substrate, said process comprising the steps of
(i) supplying the structural adhesive formulation to a hot melt applicator;
(ii) heating the structural adhesive formulation to an application temperature above its melting point and below its activation temperature;
(iii) ejecting the molten structural adhesive formulation from the hot melt applicator onto a substrate to provide a coherent bead that adheres to the substrate and is dry to the touch on cooling; and
(iv) optionally, heating the coherent bead that adheres to the substrate to the activation temperature or above thereby inducing cross-linking and volume expansion of up to 250 vol.-%.

All preferred embodiments that have been described above in relation to the structural adhesive formulation and the cartridge according to the invention analogously apply to the cartridge according to the invention and thus are not repeated hereinafter.

Step (i) of the process according to the invention involves supplying the structural adhesive formulation to a hot melt applicator.

Preferably, the hot melt applicator is a hand held hot melt gun.

The hand held melt applicator used in this invention may be any well known hand held devices such as a pump action or pressure applicator in which the structural adhesive formulation is converted into a flowable state within the applicator and expelled from the applicator onto the substrate to deliver an structural adhesive formulation layer on the substrate. The structural adhesive formulation layer may be continuous or discontinuous and may be in a predetermined pattern. We have found that the invention allows the heat activatable structural adhesive formulation to be readily applied by hand to provide an accurate deposit, such as a continuous or discontinuous bead of a heat activatable structural adhesive formulation on the substrate which may be subsequently activated at elevated temperature and is not tacky to the touch at ambient temperature upon cooling after delivery.

The structural adhesive formulation can be applied by means of simple equipment (hot melt applicator), preferably by means of a hand held hot melt gun, and does not require pump or extruder. When the hot melt applicator is equipped with a cartridge system, the hot melt applicator does not need a purging of the structural adhesive formulation in comparison to conventional melt pump or extruder. Thus, preferably the hot melt applicator is not equipped with means pumping, conveying, or otherwise transporting the structural adhesive formulation within the applicator from its input to its orifice by a force other than the force that is manually exerted by the user and air pressure. Thus, preferably the hot melt applicator is equipped neither with a pump nor with a screw.

Preferably, the structural adhesive formulation is provided in cartridges that are compatible with the hot melt applicator and that can optionally be heated prior to application by means of a commercial preheater. Cartridges have the advantage that cleaning operations of the equipment can be avoided.

Typical cartridge preheating conditions are about 10 minutes to about 30 minutes at temperatures of about 70° C. to about 100° C. A skilled person recognizes that under these conditions the structural adhesive formulation is provided in the cartridge in form of a preferably particulate material (powder, micro-pellets, pellets or bulk material), but that in the course of preheating it may be melted such that when the cartridge is subsequently transferred to the hot melt applicator, the structural adhesive formulation may be delivered to the hot melt applicator in a melted state already. For the purpose of the specification, the delivery of the structural adhesive formulation to the hot melt applicator encompasses the preceding delivery to a preheater and the subsequent delivery of an optionally melted structural adhesive formulation to the hot melt applicator.

Preferably, air pressure acts on the cartridge to dispense the structural adhesive formulation.

The structural adhesive formulation may be contained in the cartridge in form of a powder, micro-pellets, pellets or as bulk material. When the cartridges are filled with bulk material (no pellets), it may take a longer time to melt the material. The disadvantage is that the open time for application will be reduced because the material will be subjected to heat a longer time before dispensing. This can be disadvantageous in order to suppress premature heat activation. Thus, in a preferred embodiment, the cartridges are filled with a particulate material that is preferably provided in form of particles or pellets that can be melted quickly and hence can be used without any disadvantage during an extended open time window without premature heat activation.

Preferably, the hot melt applicator is equipped with a nozzle having a diameter of about 2 mm to about 8 mm.

Preferably, the hot melt applicator comprises a barrel that can be set at a temperature in the range of about 85° C. to about 115° C. and a pressure of from about 2 bars to about 8 bars, preferably about 5 bars to about 7 bars.

Step (ii) of the process according to the invention involves heating the structural adhesive formulation to an application temperature above its melting point and below its activation temperature.

Preferably, immediately prior to its application to a substrate, the heat activatable structural adhesive formulation is heated to a temperature within the range of about 90° C. to about 115° C.

As discussed particularly for automotive operations, it is desirable for the materials used in the present invention to activate at temperatures experienced during automobile paint cycles. Prior to activation, however, it is often preferable for the materials to exhibit solid and substantially non-tacky characteristics at temperatures near room temperature (e.g., between about 5° C. and about 50° C.). They should however exhibit flow and tackiness without activation at mid-level temperatures (e.g., between about 50° C. and about 120° C., typically from 85° C. to about 115° C.) so that the materials can be heated to mid-level temperatures within the hand held melt flow applicator (hot melt applicator, hot melt gun) to allow the materials to flow within the applicator and be delivered to and adhere to a substrate.

Step (iii) of the process according to the invention involves ejecting the molten structural adhesive formulation from the hot melt applicator onto a substrate to provide a coherent bead that adheres to the substrate and is dry to the touch on cooling.

Preferably, the hot melt applicator is a hand held hot melt gun. Typical conditions employed in a hot melt gun applicator is a feed of powder or pellets at ambient temperature, with the temperature of the barrel of the gun set at a temperature in the range of about 85° C. to about 115° C. and applying a pressure of from about 2 bars to about 8 bars, preferably from about 5 bars to about 7 bars, to deliver the material from the gun onto a substrate.

Preferably, the molten structural adhesive formulation is applied to the substrate at an angle of application within the range of about 45° to about 90°.

Optional step (iv) of the process according to the invention involves optionally, heating the coherent bead that adheres to the substrate to the activation temperature or above thereby inducing cross-linking and volume expansion of up to 250 vol.-%.

Preferably, in step (iv) the coherent bead is heated to a temperature in the range of about 80° C. to about 150° C., or to a temperature in the range of about 150° C. to about 220° C.

Preferably, the structural adhesive formulation is ejected onto the substrate according to this invention and then the coated substrate is shipped to the vehicle manufacturer as an integrated product which is incorporated in the vehicle production line and the structural adhesive formulation then activated to foam and cure. Accordingly the structural adhesive formulation is activated at processing temperatures higher than the melt delivery temperature, such as those encountered in an automobile assembly plant, when the material is processed along with the vehicle components at elevated temperatures or at higher applied energy levels, e.g., during e-coat preparation steps and other paint cycles. While temperatures encountered in an automobile e-coat operation may be in the range of about 145° C. to about 210° C. (about 300° F. to 400° F.), primer, filler and paint shop applications are commonly about 100° C. (about 200° F.) or higher. The material is thus activated within these ranges. If needed, blowing agent activators can be incorporated into the composition to cause expansion at the required temperatures.

The structural adhesive formulation is preferably storage stable for at least six months, more preferably at least one year.

Preferably, a pattern or array or a continuous bead of the structural adhesive formulation is ejected on a substrate for subsequent activation.

The structural adhesive formulation may be delivered in several stages so that the thickness of the layer of the structural adhesive formulation is increased. The delivery may be repeated in one or more specific areas of the substrate so that the thickness of the film of structural adhesive formulation is increased in the one or more specific areas. Alternatively, a second formulation can be applied to the first formulation. This could be of interest for example to tailor the structural adhesive formulation for maximum performance should two different substrates be bonded. Additionally the structural adhesive formulation can be applied to selected areas of the substrate.

Preferably, the substrate has ambient temperature.

If necessary the substrate may be cooled when the structural adhesive formulation is being applied. Cooling may enhance the bond between the structural adhesive formulation and the substrate and it may also reduce the likelihood of premature activation of the structural adhesive formulation. Although we have found that generally this is not necessary. Alternatively, the substrate may be heated.

In a preferred embodiment, the surface of the substrate is pretreated prior to application of the structural adhesive formulation according to the invention. Pollution of the surface can be reduced when the material, e.g. the metal, is cold. Oily surfaces are preferably degreased chemically and/or physically. The surface may be equipped with primers or adhesion promoters, although less preferred.

In another preferred embodiment, the surface of the substrate is preheated and the structural adhesive formulation is applied without additional surface preparation. The preheating may be performed by means of conventional heating equipment including but not limited to IR lamps, hot air blow systems, heat resistance, plasma, and the like. After preheating of the surface of substrate, it may allow to cool down to ambient temperature or alternatively, the structural adhesive formulation may be applied to the surface of the substrate at elevated temperature of the surface of the substrate.

The substrate on which the structural adhesive formulation is ejected is not particularly limited.

In a preferred embodiment, the substrate is a metal substrate or comprises metal. Preferably, the metal comprises steel, aluminum, and/or magnesium.

In a preferred embodiment, the substrate comprises a polymer and/or a composite material. Preferably, the polymer and/or composite material is selected from the group consisting of polyamides, fiber reinforced plastics (FRP), thermosets, bulk molding compounds (BMC), sheet molding compounds (SMC), and prepregs.

The thickness of the substrate is not particularly limited. Preferably, the substrate has a thickness of from about 50 μm to about 6000 μm, preferably from about 300 μm to about 2000 μm, more preferably from about 300 μm to about 500 μm.

Another aspect of the invention relates to a substrate provided with a coating of an structural adhesive formulation provided by the process according to the invention. Another aspect of the invention relates to a substrate comprising at its surface an expanded, i.e. heat activated structural adhesive formulation according to the invention.

All preferred embodiments that have been described above with respect to the structural adhesive formulation and the process according to the invention also analogously apply to the substrate according to the invention and therefore are not repeated hereinafter.

Another aspect of the invention relates to the use of a heat activatable structural adhesive formulation according to the invention as described above, for providing a coherent bead of the structural adhesive formulation onto a substrate by means of a hot melt applicator.

All preferred embodiments that have been described above in relation to the structural adhesive formulation according to the invention and the process according to the invention, respectively, analogously apply to the use according to the invention and thus are not repeated hereinafter.

The present invention is particularly useful in providing structural adhesive formulations in the automobile, aircraft and furniture industries particularly in automotive body repair shops and in low volume assembly lines such as in the manufacture of trucks and busses.

The present invention may be used to apply structural adhesive formulations to any substrate and may be used for the bonding together of a range of substrates. For example the structural adhesive formulation may be used to bond together metal substrates such as in vehicle manufacture. It may be used in the bonding of different substrates such as the bonding of metal to fiber reinforced composites.

1. A structural adhesive formulation, which is heat activatable at a heat activation temperature; meltable at an application temperature above its melting point and below the heat activation temperature; and solid at ambient temperature;
wherein upon heat activation the structural adhesive formulation is capable of expansion with a volumetric expansion of up to about 250 vol %; and wherein the heat activatable structural adhesive formulation comprises:
(a) an epoxy resin component;
(b) an adhesion promoter component;
(c) a cross-linking component;
(d) a blowing component;
(e) optionally, an impact modifier component;
(f) optionally, a thixotropic filler component; and
(g) optionally, a non-thixotropic filler component.

2. The structural adhesive formulation according to claim 1, which is particulate.

3. The structural adhesive formulation according to claim 2, which is in the form of a powder with an average particle size of: from about 20 μm to about 250 μm; or from about 250 μm to about 1000 μm; or from about 1000 μm to about 6000 μm;
wherein, the average particle size is expressed in terms of the geometric mean value D[4,3] with the volume as the basis for the distribution calculation (volume distribution) in accordance with ASTM E 799 using a laser particle size meter, with the powder dispersed in deionized water.

4. The structural adhesive formulation according to claim 1, wherein after heat activation at the heat activation temperature and cooling down to ambient temperature has a lap shear resistance within the range of from 8 MPa to 15 MPa; and/or a glass transition temperature of at least about 70° C., or even at least about 90° C.

5. The structural adhesive formulation according to claim 1, which has a melt viscosity at 90° C. of about 600±595 Pas, preferably within the range of from 10 mPa·s to 1000 mPa·s.

6. The structural adhesive formulation according to claim 1, wherein the epoxy resin component comprises:
(i) one or more diglycidylethers of bisphenol, wherein the bisphenol is preferably selected from the group consisting of bisphenol A, bisphenol AF, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, and bisphenol Z, e.g. bisphenol A diglycidylether (DGEBA) and/or bisphenol F diglycidylether (DGEBF); and/or
(ii) one or more resins obtainable by reacting a composition comprising formaldehyde and an aromatic alcohol, wherein the aromatic alcohol is selected from the group consisting of phenol (phenol novolac resin), cresol (cresol novolac resin), and resorcinol (resorcinol resin), e.g. a phenol novolac resin and/or a cresol novolac resin and/or a resorcinol resin; and/or
(iii) one or more resins obtainable by reacting a composition comprising epichlorohydrin and an aromatic dialcohol (phenoxy resin), preferably wherein the aromatic dialcohol is a bisphenol, wherein the bisphenol is preferably selected from the group consisting of bisphenol A, bisphenol AF, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, and bisphenol Z, e.g. poly(bisphenol A-co-epichlorohydrin) or poly(bisphenol F-co-epichlorohydrin); and/or
(iv) one or more resins obtainable by reacting a composition comprising epichlorohydrin and an cycloaliphatic dialcohol (cycloaliphatic resin), preferably a cycloaliphatic epoxy resin.

7. The structural adhesive formulation according to claim 1, wherein the weight content of the epoxy resin component, relative to the total weight of the structural adhesive formulation, is about 22.5±12.5 wt. %.

8. The structural adhesive formulation according to claim 1, wherein the adhesion promoter component comprises one or more tackifiers selected from the group consisting of aromatic hydrocarbon resins, aliphatic hydrocarbon resins, aliphatic aromatic hydrocarbon resins, rosin resins, inden-coumaron resins, and polymers of cycloaliphatic resins and alkyl aromatic resins.

9. The structural adhesive formulation according to claim 1, wherein the weight content of the adhesion promoter component, relative to the total weight of the structural adhesive formulation, is about 12.5±12.4 wt. %.

10. The structural adhesive formulation according to claim 1, wherein the cross-linking component has an activation temperature of about 120° C. or above.

11. The structural adhesive formulation according to claim 2, wherein the cross-linking component comprises:
(i) one or more curing agents selected from the group consisting of aromatic amines (e.g. 4,4′-diaminodiphenyl sulfone (DDS)), imidazole derivatives, unsubstituted dicyandiamide and substituted dicyandiamides; and/or
(ii) one or more curing accelerators selected from the group consisting of modified ureas, diuron and imidazole.

12. The structural adhesive formulation according to claim 1, wherein the weight content of the the cross-linking component, relative to the total weight of the structural adhesive formulation, is about 5.0±4.9 wt. %.

13. The structural adhesive formulation according to claim 1, wherein the blowing component has an activation temperature of about 120° C. or above.

14. (canceled)

15. The structural adhesive formulation according to claim 1, wherein the one or more chemical blowing agents are selected from the group consisting of azo compounds, such as azodicarbonamide, azodiisobutyro-nitrile, barium azodicarboxylate, nitroso compounds such as DNPT (dinitroso-pentamethylene-tetramine), N,N′-dimethyl-N,N′-dinitrosoterephthalamide, hydrazides such as benzenesulfonhydrazine, 4,4-oxy-bis-benzenesulfonylhydrazide (OBSH), or p-toluenesulfonyl hydrazine, carbazides such as 4,4-oxybenzene sulfonyl semi carbazide, p-toluene sulfonyl semicarbazide, triazines such as trihydrazino triazine and reactive couples as mixture of citric acid and sodium bicarbonate.

16. The structural adhesive formulation according to claim 15, wherein the weight content of the the blowing component, relative to the total weight of the structural adhesive formulation, is about 5.0±4.9 wt. %.

17. The structural adhesive formulation according to claim 1, wherein the impact modifier component comprises an additive based on rubber and/or core shell material.

18. The structural adhesive formulation according to claim 17, wherein the additive based on rubber is selected from reactive liquid rubbers (e.g. acrylonitrile butadiene terminated with carboxyl or amine or vinyl), nitrile rubbers, ethylene propylene diene monomer rubber (EPDM rubbers), butyl rubbers, and styrene butadiene rubbers (SBR).

19. The structural adhesive formulation according to claim 17, wherein the weight content of the the impact modifier component, relative to the total weight of the structural adhesive formulation, is about 7.5±7.4 wt.-%.

20. The structural adhesive formulation according to claim 1, wherein the thixotropic filler component comprises or essentially consists of one or more thixotropic fillers selected from the group consisting of fumed silica, bentonite, quaternary ammonium salts, and aramid fibers (e.g. PAA, PA-MXD-6, PPA, PA MPD-I, PA PPD-T).

21-25. (canceled)

26. The structural adhesive formulation according to claim 1, for providing a coherent bead of the structural adhesive formulation onto a substrate by means of a hot melt applicator, wherein the coherent bead adheres to the substrate at the application temperature and is dry to the touch on cooling to ambient temperature, and wherein upon heat activation at the activation temperature the structural adhesive formulation is capable of cross-linking and volumetric expanding.

27-43. (canceled)
